(19) United States
(12) Patent Application Publication
(10) Pub. No.: US 2010/0140859 A1
(43) Pub. Date: Jun. 10, 2010

(54) Moulding Support Device

(76) Inventor: Giuseppe VALENTE, Montreal (CA)

Correspondence Address: GOWLING, LAFLEUR AND HENDERSON LLP, 1. PLACE VILLE-MARIE, 37TH FLOOR, MONTREAL, QC, CA

(21) Appl. No.: 12/621,911

(22) Filed: Nov. 19, 2009

Related U.S. Application Data
(60) Provisional application No. 61/193,588, filed on Dec. 9, 2008.

(51) Int. Cl. B23Q 1/25

(52) U.S. Cl. 269/55

(57) ABSTRACT

The present invention relates to a moulding support device suitable for use in the temporary support of a moulding during installation. The moulding support device comprises a base unit, a temporary fixing means mounted on the base unit to fix the device in a temporary mode to a substrate and allow easy removal, and at least one contact surface on the base unit to make contact with a moulding and to hold the latter in position in relation to the substrate.

### FIELD OF THE INVENTION

The present invention relates to a moulding support device suitable for use in the temporary support of a moulding during installation involving fixture to a substrate such as a wall or ceiling to give a decorative appearance thereto.

### BACKGROUND OF THE INVENTION

The use of mouldings in buildings for decorative purposes is widespread and generally involves the placement of a cornice at the juncture between a ceiling and a wall or walls within a room or other chamber of an edifice. The installation involves the provision of a temporary support, conventionally manual, to locate the cornice in the correct position for installation by suitable fixture, for example a bonding agent, screws or finishing nails. The cornice may be produced from plaster or wood or indeed synthetic material such as plastics. The cornice is usually made in what can be unwieldy lengths which may have simple or complex decorative profiles making it difficult for one person to install.

Various proposals have been made for temporary supports to be utilized in the placement of furnishings, for example crown mouldings, wall mounted cabinets and the installation of construction elements such as gypsum ceiling boards. In this connection, in respect of ceiling boards, support platforms are available which may be cranked up to the required elevated position to hold the boards in position for fixture to the ceiling framework. Jacks are also conventionally available for providing such support for the installation of cabinetry and indeed cornices.

However, supports of this kind are generally and of necessity of some size and bulk making their usage difficult in any but the larger environments where space is not at a premium during construction work.

Accordingly, there is a need for an improved moulding support device which focuses on the specific task of holding a moulding in place ready for fixture, and at the same time affording a simple and easy operation.

### SUMMARY OF THE INVENTION

It is therefore a general object of the present invention to provide an improved moulding support device.

An advantage of the present invention is that the device has an easy to operate clamping arrangement for applying the device to a substrate temporarily without damage thereto and at the correct location and orientation, the substrate being any flat surface that can be used as a clamping surface, such as a wall, a ceiling, a wall mounted cabinet or the like.

An advantage of the present invention is that the device with a hand-operated suction cup facilitates fixing of the device in a temporary mode and allows easy removal without spoiling the surface texture of the substrate.

A further advantage of the present invention is that the moulding support device has the capacity for adjustment to accommodate varied moulding profiles and to hold them in place as appropriate.

A still further advantage of the present invention is that the device of the present invention has an adjustment facility that is variable and in this respect the device has an indexing means for allowing such adjustability.

In accordance with an object of the present invention, there is provided a moulding support device comprising a base unit, a hand-operated suction cup mounted on the base unit adapted in use to secure the base unit temporarily to a substrate, and at least one contact surface on the base unit adapted in use to make contact with a moulding to hold the moulding in position in relation to the substrate.

Conveniently, the at least one contact surface is on a support element that is preferably adjustably mounted with respect to the base unit.

The base unit preferably includes a base plate into which the hand-operated suction cup is mounted, with two sides and an end closure, which latter is extended beyond the base plate for abutment with the surface of the substrate such that in use in position on the substrate slippage of a moulding behind the base unit is prevented.

In one embodiment of the present invention, the end closure of the base unit, acting as the at least one contact surface, is static and orthogonal to the base plate. In an alternative embodiment the end closure is angularly orientated in relation to the base plate, for example within a range of 105° to 115°. In a still further embodiment, the end closure is itself pivotally mounted to the base unit and effectively constitutes the support element, the angular disposition of the end closure in relation to the base plate being adjustable using an adjustment mechanism of the same or similar kind as described herein below.

The support element has wing pieces which conveniently bridge the sides of the base unit and are pivotally mounted thereto. An adjustment mechanism is provided as between the side or sides of the base unit and the wing pieces of the support element.

The adjustment mechanism may be in the form of an indexing array on at least one of the wing pieces or sides of the base unit engageable by a pin on at least one of the adjacent sides of the base unit or wing pieces. The pin may be spring loaded (not shown) for engagement with the indexing array that may be a range of indexing drilled holes or machined recesses along a radius in the relevant wing piece.

In the alternative, the adjustment mechanism may comprise in combination an arcuate slot formed in a wing piece of the support element, and screw stud fixed on the side of the base unit with a wing nut adjustment for locking the wing piece to the side of the base unit in the desired angular relationship.

Conveniently, the position of the pivoting axis is also adjustable to suit special configurations. To this end, corresponding arcs of indexing holes or slots are obviously provided.

The base unit may be provided on each side thereof with a guide or guides for the reception of slidable bars which may advantageously have an enlarged part thereof extending beyond the limits of the unit and so dimensioned as to provide a variable spacer facility when in use the moulding support device is in position against a substrate.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a perspective front elevation of a first embodiment of a moulding support device in accordance with the present invention and showing a moulding in position against a ceiling and wall being supported by the device prior to fixture;

FIG. 1a is a perspective front elevation of a second embodiment of a moulding support device in accordance with the present invention;

FIG. 2 is an exploded view of the moulding support device illustrated in FIG. 1;

FIG. 2a is an exploded view of the moulding support device illustrated in FIG. 1a;

FIG. 3 is a side elevation of a third embodiment of a moulding support device in accordance with the present invention and showing the manner of operation of the device of the invention;

FIG. 4 is a side view of the device of FIG. 3 with the device in position in relation to a ceiling or wall with slidable bars in position to support a moulding intended to lie flat against the relevant substrate;

FIG. 5 is a diagrammatic depiction of the varying depths of moulding that may be accommodated and supported between the slidable bars as shown in FIG. 4 and the substrate; and

FIG. 6 is a perspective front elevation of a fourth embodiment of the present invention.

### DETAILED DESCRIPTION OF THE INVENTION

With reference to the annexed drawings the preferred embodiments of the present invention will be herein described for indicative purpose and by no means as of limitation.

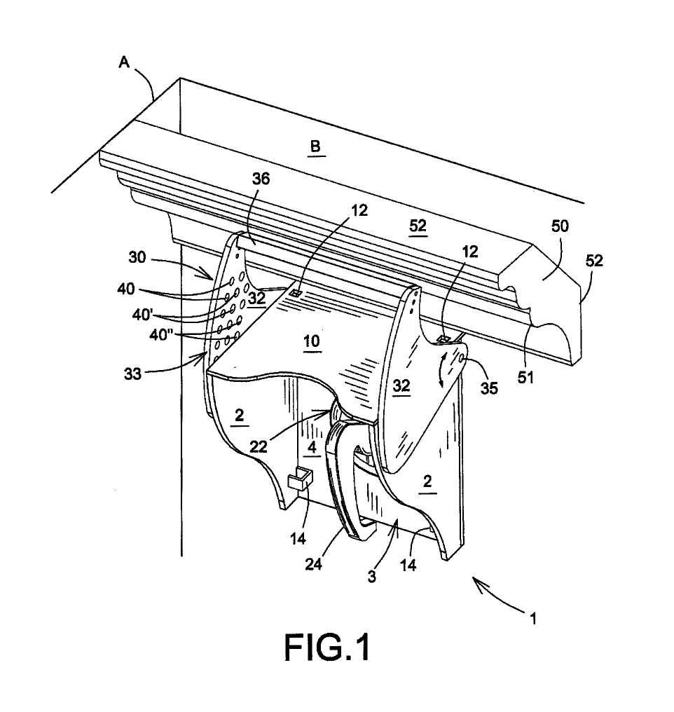

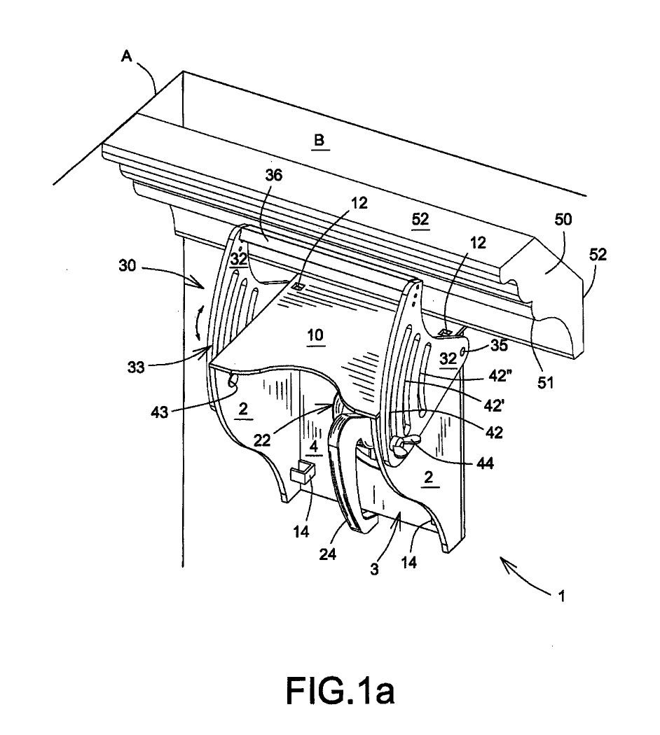

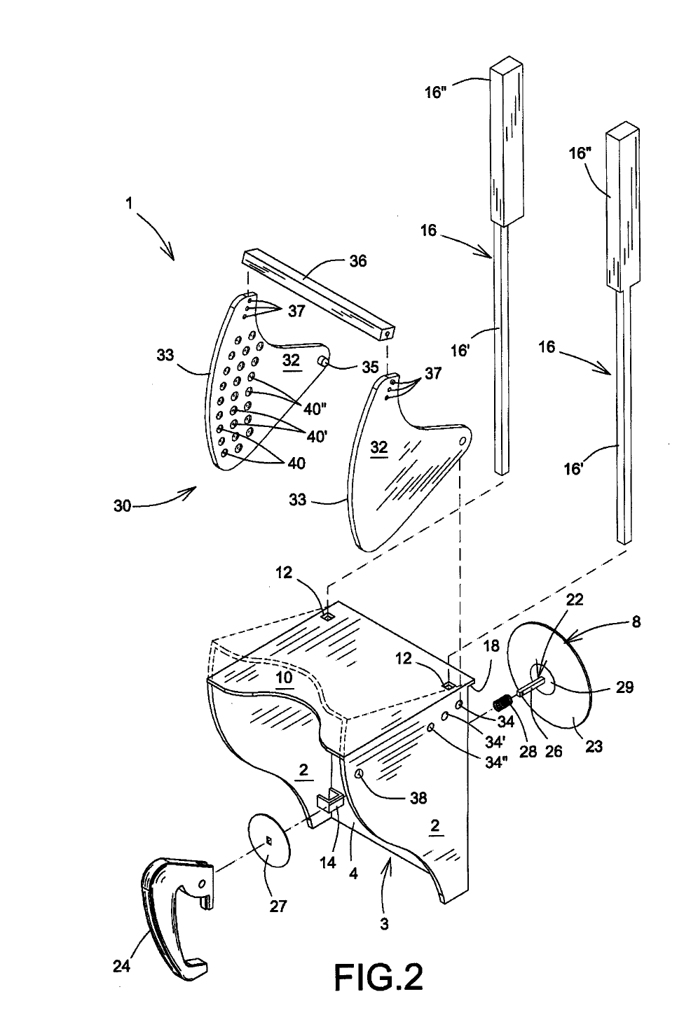

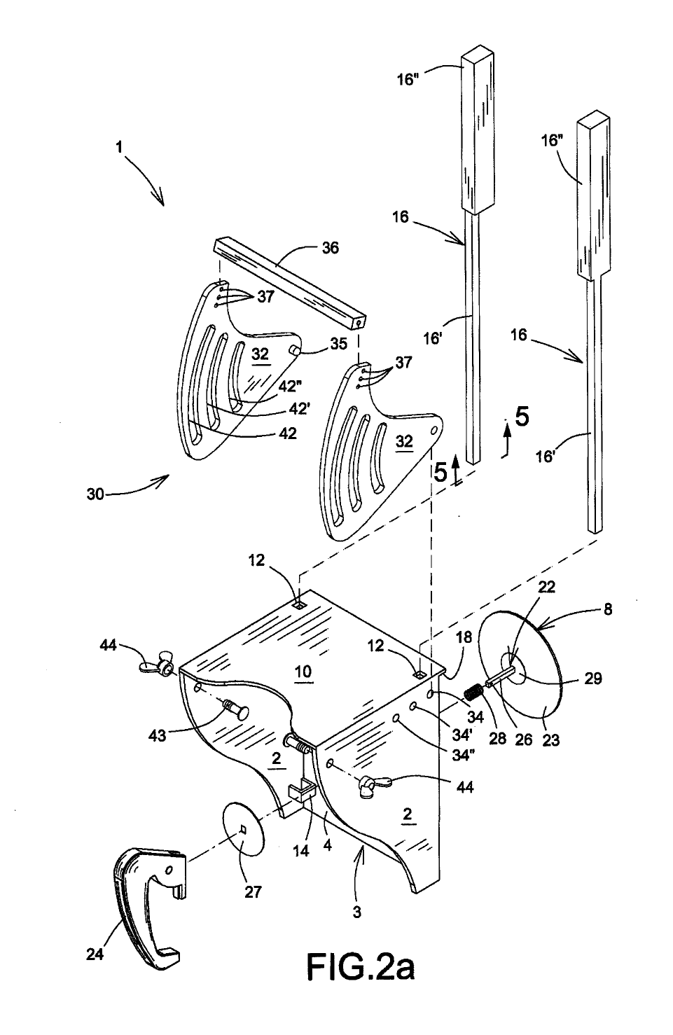

In FIGS. 1 and 2, a first embodiment of a moulding support device is illustrated and includes a channel-like base unit 1 having side walls 2 defining therebetween a channel 3 with a base plate 4 in which is formed an aperture 6 for accommodating the mounting of a hand-operated suction cup shown generally at 8. An end closure 10 extends between the side walls 2 at one end of the channel 3 and has two slide holes 12 at the lower margins of the closure at each lateral extent thereof, the holes being aligned with guide saddles 14 located on the inner surfaces of the side walls 2. Removable slidable bars 16 are accommodated within the slide holes 12 and the saddles 14, the bars 16 being shown in FIG. 2 for the sake of completeness, but the bars 16 are not required for the operation of this embodiment with the moulding depicted.

The end closure 10 extends beyond the base plate 4 to provide a stop 18 for a purpose hereinafter described.

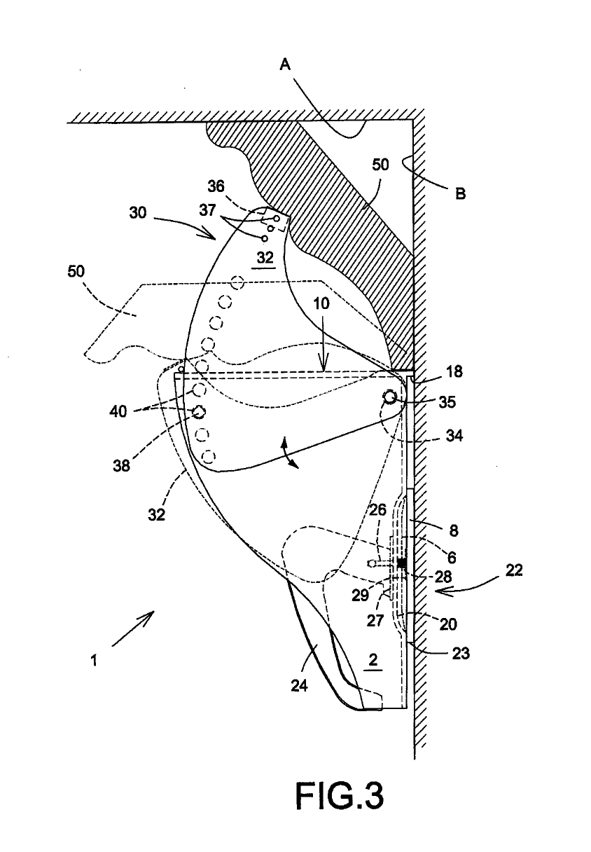

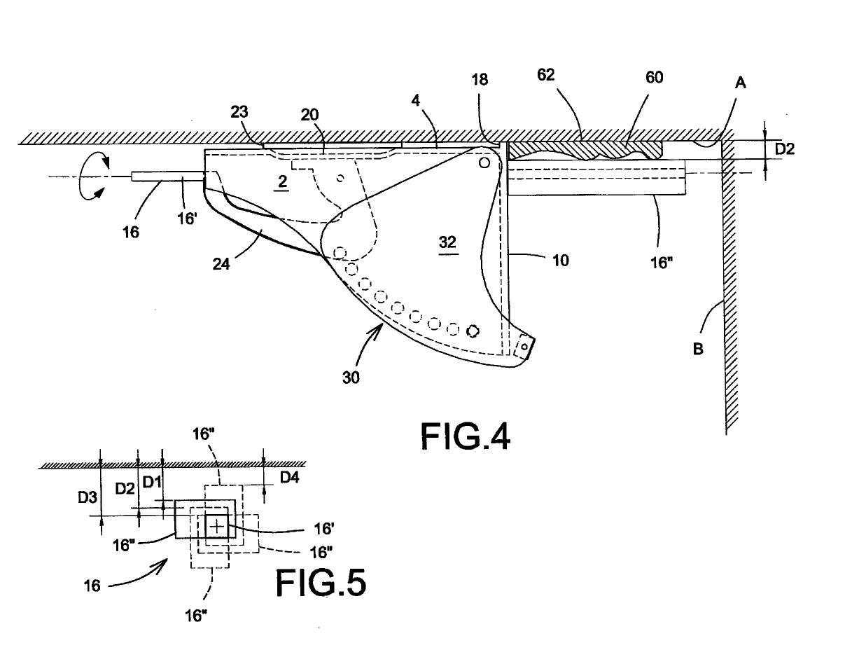

The base plate 4 is recessed on its under surface as at 20 (as better seen in FIGS. 3 and 4) for the reception of the flexible disc 23 of the mechanism 22 of the suction cup 8. The mechanism 22 includes an operating handle 24 suitably connected to the spindle 26 of the mechanism 22 and abutting to a washer 27, the spindle 26 extending through the aperture 6 in the base plate. It will be understood that the hand-operated suction cup 8 and associated mechanism 22 are conventional in character, with compression coil spring 28 and washer 29, for example suction cups of the kind available from the Anver® Corporation would be suitable for use in this invention. As seen in FIGS. 3 and 4, the stop 18 is essentially present to make up for the thickness of the disc 23. It will be understood that the hand-operated suction cup 8 could be replaced with any types of temporary securing (or affixing) means to secure the support device temporarily to a surface of a substrate.

A support element 30 comprises two wing pieces 32 which bridge the side walls 2 and which are both pivotally attached thereto as by pins 35 of wing pieces engaging corresponding bore 34 of the side walls, as shown. The wing pieces 32 are of generally sector shape with a support rod 36 extending the extremities of the arcuate edge 33 of each wing piece 32, the rod 36 being adjustable in position on the wing pieces 32, as indicated by holes 37 (see FIGS. 2 and 2a). At the end of the side wall 2 of the base unit 1 distal from the pin 34 one or both of the side walls is provided with a preferably rounded pin 38 for registration with one of a series 39 of indexing holes or recesses 40 formed in one or preferably both wing pieces 32 along the arcuate edge 33 and spaced therefrom. The support unit 30 is adjustable in position in relation to the base unit 1 by pivotal movement of the wing pieces 32 and alteration of the registration position of the pin 38 in one of the indexing recesses 40 of the series 39.

In FIG. 1a, the second embodiment of the present invention differs from the first only in relation to the manner of clamping the wing pieces 32 to the side walls 2 of the base unit 1. In this second embodiment, one of both wing pieces 32 is provided with an arcuate slot 42 through which a threaded stud 43 extends from and is mounted to one of the side wall 2 of the base unit. A locking wingnut 44 engages the stud 43 for locking the relevant wing piece 32 to the side wall 2 in the desired angular position.

Conveniently, as shown in FIGS. 1 to 2a, the position of the pivoting axis of the pins 35 is also adjustable in bores 34, 34′, 34″, which may prove useful to suit special working configurations. To this end, corresponding arcs or series 39, 39′, 39″ of indexing recesses 40, 40′, 40″ or arcuate slots 42, 42′, 42″ are provided for registration with pin 38 or threaded stud 43.

A third embodiment shown in FIG. 3 illustrates only one series 39 of recesses 40 in the two wing pieces 32, for registration with rounded pin 38.

In operation of the first, second and third embodiments, the moulding support device is disposed in a suitable supporting position adjacent a ceiling A and a wall B for the purpose of locating and temporarily supporting a length of coving 50 intended in completion to constitute a cornice for a room (not shown) of which the wall and the ceiling form part of the bounding structure. As will readily be seen the coving 50 is contoured at 51 to give a decorative appearance and is provided with flats 52 for engagement with the ceiling A and the wall B. The length of coving 50 is held and supported by the device with the base unit 1 being secured to the wall B through the agency of the suction cup 8 which is operated by its handle 24 to give the required vacuum. The support element 30 is pivoted into a suitable position to provide contact with and support for the coving 50 as shown in the figures with the rod 36 contacting the coving. The angular disposition of the support element 30 in relation to the base unit 1 is effected by adjustment of the wing pieces through the use of the pin and indexing holes or by the slot and wing nut arrangements as necessary and as hereinbefore described. It will be noted that the coving 50 is also supported by the stop 18 of the end closure 10 of the base unit 1. The coving 50 is held in position by the device until secure fixing thereof has been achieved as between the coving and the ceiling A and the wall B. The fixing may be effected by the use of a bonding agent which may require the application of pressure during curing, or may be effected by suitable fasteners for example screws or finishing nails. Once the fixing of the coving has been achieved, the suction cup 8 is released and the device removed for further use.

In FIG. 4, the third embodiment is illustrated in place locked onto a ceiling A (or it may be a wall B) and in this mode of deployment the slidable bars 16 are in use. Initially a contoured moulding 60 with a flat backing 62 is elevated to the contact position in relation to the ceiling A such as by the use of the support element 30 if desired and then the slidable bars 16 are extended to provide a holding support for the moulding 60 across its full width with the element being withdrawn to a parked position as shown in the figure. Each slidable bar 16, as can more clearly be seen in FIGS. 2 and 2a varies in cross-sectional dimension with a narrow square section 16′ enlarging to an eccentric rectangularly-shaped section 16″. As can be seen from FIG. 5 the differing cross-sectional dimensions afford the ability of the bars to accommodate differing thicknesses, D1, D2, D3 and D4 of moulding, the axial orientation of the bars being changed in correspondence to the thickness of moulding selected.

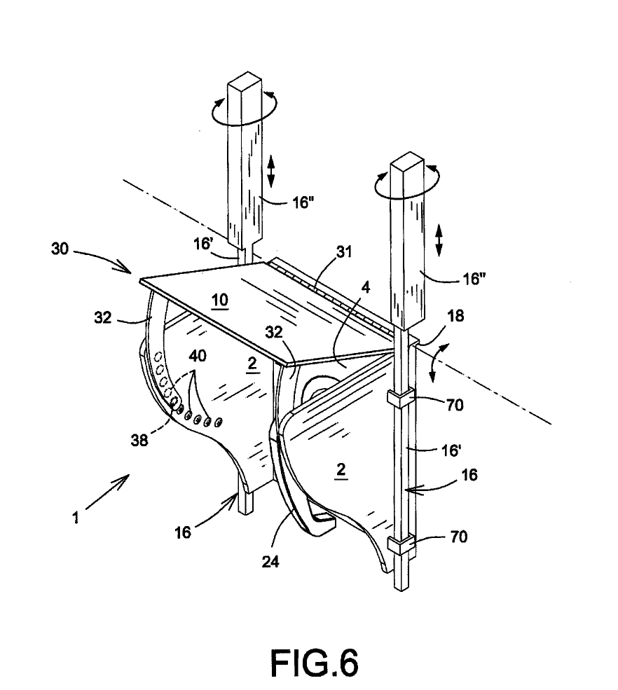

Turning now to FIG. 6, it will be noted that in this fourth embodiment of moulding support device, guideways 70 are provided on the outer surfaces of the side walls 2 of the base unit 1 for accommodating the bars 16. In this embodiment the support element 30 comprises the end closure 10, which is in the form of a plate pivotable about the end extremity of the base plate 4, as shown by hinge 31, with the stop 18 remaining fixed relative to the base unit 1. The element 30 is provided with arcuate wing pieces 32 in strip form one or both of which is provided with a pin 38 for registration in one of a series 39 of recesses 40 formed in a side wall 2 of the base unit 1. In operation of this embodiment of the device, a moulding (not shown in this figure) is placed on the end closure 10 and elevated to the appropriate location and the bars 16 are then positioned with the appropriate thickness to hold the moulding in situ for fixture.

It will be understood that the support element 30 of the fourth embodiment as shown in FIG. 6 could also be confectioned to provide contact with and support for the coving 50. In this embodiment, the end closure 10 of the support element 30 is also provided with a support structure. Of course, the person skilled in the art will know how to connect the support structure to the end closure 10 of the support element 30.

The present invention provides a simple, effective and relatively inexpensive tool for assisting in the correct positioning and fixture of mouldings and the like, thus avoiding the difficulties normally associated with application of this kind of decorative finishing.

While a preferred embodiment of the present invention has been illustrated and described herein, it will be appreciated that various changes and modifications as may be therein without departing from the spirit of the invention as defined by the scope of the appended claims. For example, it will be understood that any types of adjustment mechanism can be used to connect, joint, attach, fix or adjust the different constituents of the moulding support device of the present invention. Furthermore, it will be understood that this support device could be used to hold in place for a certain period of time any types of items to be installed.

1. A moulding support device comprising
a base unit,
a temporary securing means mounted on the base unit adapted to secure the support device temporarily to a surface of a substrate, and
at least one contact surface on the base unit adapted in use to make contact with a moulding to hold the moulding in position in relation to the surface of the substrate.

2. The moulding support device of claim 1, wherein the temporary securing means is a hand-operated suction cup.

3. The moulding support device of claim 2, wherein the base unit comprises a base plate.

4. The moulding support device of claim 3, wherein the hand-operated suction cup is mounted on the base plate of the base unit.

5. The moulding support device of claim 4, wherein said base plate further comprises side walls.

6. The moulding support device of claim 5, wherein said base plate further comprises an end closure extending between the side walls of the base plate.

7. The moulding support device of claim 6, wherein said end closure extends beyond the base plate for abutment with the surface of the substrate to provide a stop and to hold the moulding in contact with the substrate.

8. The moulding support device of claim 7, wherein the end closure of the base unit is orthogonal to the base plate or angularly oriented in relation to the base plate.

9. The moulding support device of claim 8, wherein the end closure is pivotally mounted to the base unit.

10. The moulding support device of claim 9, wherein the at least one contact surface is on a support element of the base unit.

11. The moulding support device of claim 10, wherein said support element is the end closure of the base plate.

12. The moulding support device of claim 11, wherein said support element is adjustable in position in relation to the base unit.

13. The moulding support device of claim 12, wherein said support element is pivotally attached to the base plate in order to put in contact the support element with the moulding to hold the moulding in contact with the substrate.

14. The moulding support device of claim 13, wherein said support element is pivotally attached to the side walls of the base plate in order to put in contact the support element with the moulding to hold the moulding in contact with the substrate.

15. The moulding support device of claim 14, wherein said support element comprises wing pieces which are pivotally attached to the side walls of the base plate by an adjustment mechanism.

16. The moulding support device of claim 15, wherein said adjustment mechanism is provided between the side or the sides of the base plate and the wing pieces of the support element.

17. The moulding support device of claim 10, wherein the at least one contact surface is on a support rod of the support element.

18. The moulding support device of claim 17, wherein said support rod is adjustable in position in relation to the support element depending on the dimension of the moulding.

19. The moulding support device of claim 1, wherein the base unit further comprises a guide or guides for the reception of a slidable bar or slidable bars wherein said slidable bar or slidable bars provide a holding support for the moulding across its full width.

20. The moulding support device of claim 19, wherein the slidable bar varies in cross-sectional dimension to afford the ability to the bar to accommodate differing thickness of the moulding.
